(19) United States
(12) Patent Application Publication
(10) Pub. No.: US 2009/0323144 A1
(43) Pub. Date: Dec. 31, 2009

(54) ILLUMINATION DEVICE WITH HOLOGRAPHIC LIGHT GUIDE

(75) Inventors: Russell Wayne Gruhlke, Milpitas, CA (US); Clarence Chui, San Jose, CA (US); Marek Mienko, San Jose, CA (US); Gang Xu, Cupertino, CA (US); Ion Bita, San Jose, CA (US)

Correspondence Address: KNOBBE, MARTENS, OLSON & BEAR, LLP, 2040 MAIN STREET, FOURTEENTH FLOOR, IRVINE, CA, 92614, US

(73) Assignee: QUALCOMM MEMS Technologies, Inc., San Diego, CA (US)

(21) Appl. No.: 12/251,239

(22) Filed: Oct. 14, 2008

Related U.S. Application Data
(60) Provisional application No. 61/077,098, filed on Jun. 30, 2008.

(51) Int. Cl. G02B 5/32; G01B 7/30

(52) U.S. Cl. 359/15; 430/2; 359/1

(57) ABSTRACT

An illumination device includes a holographic film and a light source, such as a point light source. The point light source is positioned at an edge of the holographic film and has a light emitting face that faces the edge of the holographic film. The holographic film includes a hologram formed of diffractive refractive index structures. The density of the diffractive refractive index structures increases with increasing distance from the light source. Light is propagated from the light source through the holographic film, such as by total internal reflection. The diffractive refractive index structures turn the light, thereby causing the light to propagate out of the holographic film in a desired direction. In some embodiments, the light propagating out of the holographic film has a high uniformity across the surface of the holographic film.

### REFERENCE TO RELATED APPLICATIONS

This application claims the priority benefit under 35 U.S.C. §119(e) of Provisional Patent Application No. 61/077,098, filed Jun. 30, 2008.

### BACKGROUND

1. Field of the Invention

This invention relates generally to illumination devices. More particularly, this invention relates to illumination devices utilizing holographic structures to guide light to, for example, illuminate a display. This invention also relates to methods of use and fabrication of these devices.

2. Description of Related Technology

Microelectromechanical systems (MEMS) include micro mechanical elements, actuators, and electronics. Micromechanical elements may be created using deposition, etching, and/or other micromachining processes that etch away parts of substrates and/or deposited material layers or that add layers to form electrical and electromechanical devices. One type of MEMS device is called an interferometric modulator. As used herein, the term interferometric modulator or interferometric light modulator refers to a device that selectively absorbs and/or reflects light using the principles of optical interference. In certain embodiments, an interferometric modulator may comprise a pair of conductive plates, one or both of which may be transparent and/or reflective in whole or part and capable of relative motion upon application of an appropriate electrical signal. In a particular embodiment, one plate may comprise a stationary layer deposited on a substrate and the other plate may comprise a metallic membrane separated from the stationary layer by an air gap. As described herein in more detail, the position of one plate in relation to another can change the optical interference of light incident on the interferometric modulator. Such devices have a wide range of applications, and it would be beneficial in the art to utilize and/or modify the characteristics of these types of devices so that their features can be exploited in improving existing products and creating new products that have not yet been developed.

### SUMMARY

In some embodiments, an illumination apparatus is provided. The illumination apparatus comprises a holographic film comprising a hologram. The hologram comprises a plurality of diffractive refractive index structures. A point light source is disposed at an edge of the holographic film. A light emitting face of the point light source facing the edge. A density of the diffractive refractive index structures increases with increasing distance from the light source.

In some other embodiments, an apparatus is provided for illuminating a display. The apparatus comprises a holographic film having a plurality of diffractive refractive index structures recorded therein. The diffractive refractive index structures are configured to diffract light predominantly at wavelengths corresponding to the colors red, green and blue. A light source is disposed at an edge of the holographic film.

In some other embodiments, an illumination apparatus is provided. The illumination apparatus comprises a first means for generating light and directing the light through a planar body; and a second means for uniformly holographically redirecting the light out of a surface of the body.

In some other embodiments, a method for illuminating a display is provided. The method comprises providing a point light source at an edge of a holographic film. Light from the point light source is projected directly into the edge of the holographic film, the light propagating through the holographic film. The light contacts diffractive refractive index structures and is directed out of a major surface of the holographic film. The power per area of light redirected towards picture elements of the display is substantially uniform across the major surface of the holographic film.

In some other embodiments, a method for manufacturing a display device is provided. The method comprises providing a holographic film comprising a hologram, the hologram comprising a plurality of diffractive refractive index structures. A density of the diffractive refractive index structures increases with increasing distance from the light source. A point light source is attached at an edge of the holographic film. A light emitting face of the point light source faces the edge. A display is attached to the holographic film.

### BRIEF DESCRIPTION OF THE DRAWINGS

FIG. 1 is an isometric view depicting a portion of one embodiment of an interferometric modulator display in which a movable reflective layer of a first interferometric modulator is in a relaxed position and a movable reflective layer of a second interferometric modulator is in an actuated position.

FIG. 2 is a system block diagram illustrating one embodiment of an electronic device incorporating a 3×3 interferometric modulator display.

FIG. 3 is a diagram of movable mirror position versus applied voltage for one exemplary embodiment of an interferometric modulator of FIG. 1.

FIG. 4 is an illustration of a set of row and column voltages that may be used to drive an interferometric modulator display.

FIG. 5A illustrates one exemplary frame of display data in the 3×3 interferometric modulator display of FIG. 2.

FIG. 5B illustrates one exemplary timing diagram for row and column signals that may be used to write the frame of FIG. 5A.

FIGS. 6A and 6B are system block diagrams illustrating an embodiment of a visual display device comprising a plurality of interferometric modulators.

FIG. 7A is a cross section of the device of FIG. 1.

FIG. 7B is a cross section of an alternative embodiment of an interferometric modulator.

FIG. 7C is a cross section of another alternative embodiment of an interferometric modulator.

FIG. 7D is a cross section of yet another alternative embodiment of an interferometric modulator.

FIG. 7E is a cross section of an additional alternative embodiment of an interferometric modulator.

FIG. 8A is a cross section of an embodiment of a display device.

FIG. 8B is a cross section of another embodiment of a display device.

FIG. 8C is a perspective view of an embodiment of a display device.

FIG. 8D is a perspective view of another embodiment of a display device.

FIG. 9A is a top plan view of the display device of FIG. 8C.

FIG. 9B is a top plan view of the display device of FIG. 8D.

FIGS. 10A and 10B are top plan views of a holographic film.

FIG. 10C is a cross section of the structure of FIGS. 10A and 10B.

FIG. 11A is a cross section of a holographic film and related support structure.

FIG. 11B is a top plan view of an embodiment of the holographic film and related support structure of FIG. 11A.

FIG. 11C is a top plan view of another embodiment of the holographic film and related support structure of FIG. 11A.

### DETAILED DESCRIPTION

The following detailed description is directed to certain specific embodiments. However, the teachings herein can be applied in a multitude of different ways. In this description, reference is made to the drawings wherein like parts are designated with like numerals throughout. The embodiments may be implemented in any device that is configured to display an image, whether in motion (e.g., video) or stationary (e.g., still image), and whether textual or pictorial. More particularly, it is contemplated that the embodiments may be implemented in or associated with a variety of electronic devices such as, but not limited to, mobile telephones, wireless devices, personal data assistants (PDAs), hand-held or portable computers, GPS receivers/navigators, cameras, MP3 players, camcorders, game consoles, wrist watches, clocks, calculators, television monitors, flat panel displays, computer monitors, auto displays (e.g., odometer display, etc.), cockpit controls and/or displays, display of camera views (e.g., display of a rear view camera in a vehicle), electronic photographs, electronic billboards or signs, projectors, architectural structures, packaging, and aesthetic structures (e.g., display of images on a piece of jewelry). MEMS devices of similar structure to those described herein can also be used in non-display applications such as in electronic switching devices.

Some embodiments disclosed herein include an illumination system including a light source and a light guide panel having a holographic light “turning” film. The light source may be a point light source (e.g., a light emitting diode (LED)), or a line light source. The holographic film includes a hologram having diffractive refractive index (DRI) structures. Light from the light source is injected into the light guide panel, propagates through the panel and contacts the DRI structures. The DRI structures redirect the light out of the panel, e.g., to a display formed of, e.g., interferometric modulators. In some embodiments, the density of the DRI structures increases with increasing distance from the light source. Advantageously, the flux of the light redirected out of the panel can be highly uniform over a desired area of the panel, e.g., an area corresponding to the active area of the display where pixels are disposed.

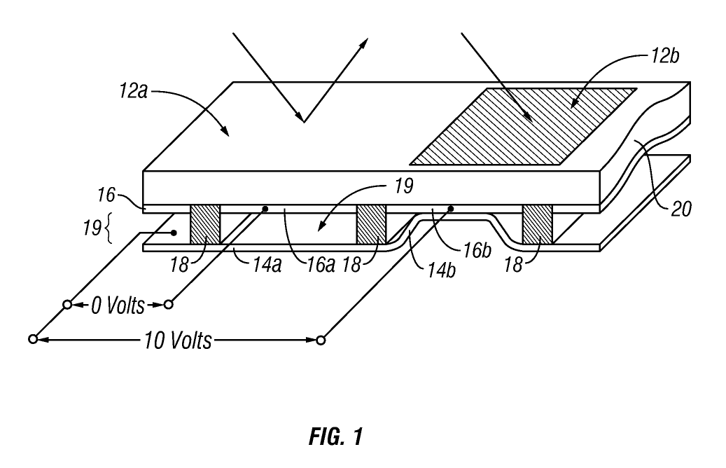

One interferometric modulator display embodiment comprising an interferometric MEMS display element is illustrated in FIG. 1. In these devices, the pixels are in either a bright or dark state. In the bright (“relaxed” or “open”) state, the display element reflects a large portion of incident visible light to a user. When in the dark (“actuated” or “closed”) state, the display element reflects little incident visible light to the user. Depending on the embodiment, the light reflectance properties of the “on” and “off” states may be reversed. MEMS pixels can be configured to reflect predominantly at selected colors, allowing for a color display in addition to black and white.

FIG. 1 is an isometric view depicting two adjacent pixels in a series of pixels of a visual display, wherein each pixel comprises a MEMS interferometric modulator. In some embodiments, an interferometric modulator display comprises a row/column array of these interferometric modulators. Each interferometric modulator includes a pair of reflective layers positioned at a variable and controllable distance from each other to form a resonant optical gap with at least one variable dimension. In one embodiment, one of the reflective layers may be moved between two positions. In the first position, referred to herein as the relaxed position, the movable reflective layer is positioned at a relatively large distance from a fixed partially reflective layer. In the second position, referred to herein as the actuated position, the movable reflective layer is positioned more closely adjacent to the partially reflective layer. Incident light that reflects from the two layers interferes constructively or destructively depending on the position of the movable reflective layer, producing either an overall reflective or non-reflective state for each pixel.

The depicted portion of the pixel array in FIG. 1 includes two adjacent interferometric modulators 12a and 12b. In the interferometric modulator 12a on the left, a movable reflective layer 14a is illustrated in a relaxed position at a predetermined distance from an optical stack 16a, which includes a partially reflective layer. In the interferometric modulator 12b on the right, the movable reflective layer 14b is illustrated in an actuated position adjacent to the optical stack 16b.

The optical stacks 16a and 16b (collectively referred to as optical stack 16), as referenced herein, typically comprise several fused layers, which can include an electrode layer, such as indium tin oxide (ITO), a partially reflective layer, such as chromium, and a transparent dielectric. The optical stack 16 is thus electrically conductive, partially transparent and partially reflective, and may be fabricated, for example, by depositing one or more of the above layers onto a transparent substrate 20. The partially reflective layer can be formed from a variety of materials that are partially reflective such as various metals, semiconductors, and dielectrics. The partially reflective layer can be formed of one or more layers of materials, and each of the layers can be formed of a single material or a combination of materials.

In some embodiments, the layers of the optical stack 16 are patterned into parallel strips, and may form row electrodes in a display device as described further below. The movable reflective layers 14a, 14b may be formed as a series of parallel strips of a deposited metal layer or layers (orthogonal to the row electrodes of 16a, 16b) to form columns deposited on top of posts 18 and an intervening sacrificial material deposited between the posts 18. When the sacrificial material is etched away, the movable reflective layers 14a, 14b are separated from the optical stacks 16a, 16b by a defined gap 19. A highly conductive and reflective material such as aluminum may be used for the reflective layers 14, and these strips may form column electrodes in a display device. Note that FIG. 1 may not be to scale. In some embodiments, the spacing between posts 18 may be on the order of 10-100 um, while the gap 19 may be on the order of <1000 Angstroms.

With no applied voltage, the gap 19 remains between the movable reflective layer 14a and optical stack 16a, with the movable reflective layer 14a in a mechanically relaxed state, as illustrated by the pixel 12a in FIG. 1. However, when at potential (voltage) difference is applied to a selected row and column, the capacitor formed at the intersection of the row and column electrodes at the corresponding pixel becomes charged, and electrostatic forces pull the electrodes together. If the voltage is high enough, the movable reflective layer 14 is deformed and is forced against the optical stack 16. A dielectric layer (not illustrated in this Figure) within the optical stack 16 may prevent shorting and control the separation distance between layers 14 and 16, as illustrated by actuated pixel 12b on the right in FIG. 1. The behavior is the same regardless of the polarity of the applied potential difference.

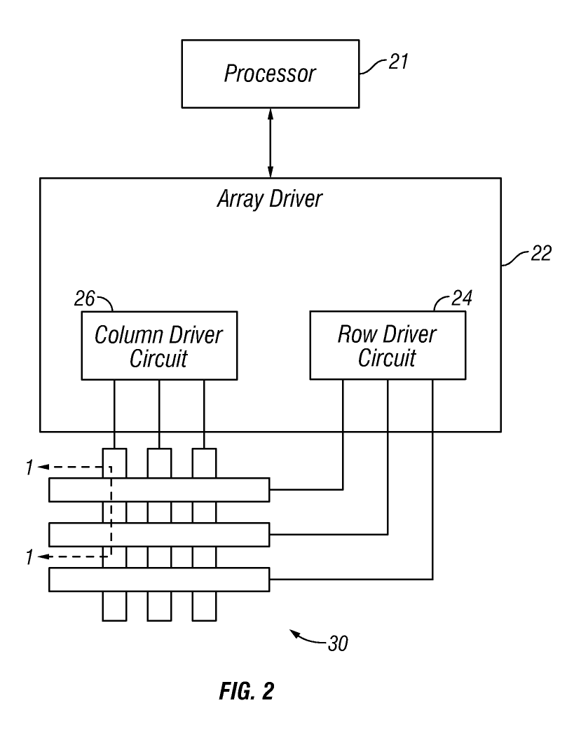

FIGS. 2 through 5 illustrate one exemplary process and system for using an array of interferometric modulators in a display application.

FIG. 2 is a system block diagram illustrating one embodiment of an electronic device that may incorporate interferometric modulators. The electronic device includes a processor 21 which may be any general purpose single- or multi-chip microprocessor such as an ARM®, Pentium®, 8051, MIPS®, Power PC®, or ALPHA®, or any special purpose microprocessor such as a digital signal processor, microcontroller, or a programmable gate array. As is conventional in the art, the processor 21 may be configured to execute one or more software modules. In addition to executing an operating system, the processor may be configured to execute one or more software applications, including a web browser, a telephone application, an email program, or any other software application.

In one embodiment, the processor 21 is also configured to communicate with an array driver 22. In one embodiment, the array driver 22 includes a row driver circuit 24 and a column driver circuit 26 that provide signals to a display array or panel 30. The cross section of the array illustrated in FIG. 1 is shown by the lines 1-1 in FIG. 2. Note that although FIG. 2 illustrates a 3×3 array of interferometric modulators for the sake of clarity, the display array 30 may contain a very large number of interferometric modulators, and may have a different number of interferometric modulators in rows than in columns (e.g., 300 pixels per row by 190 pixels per column).

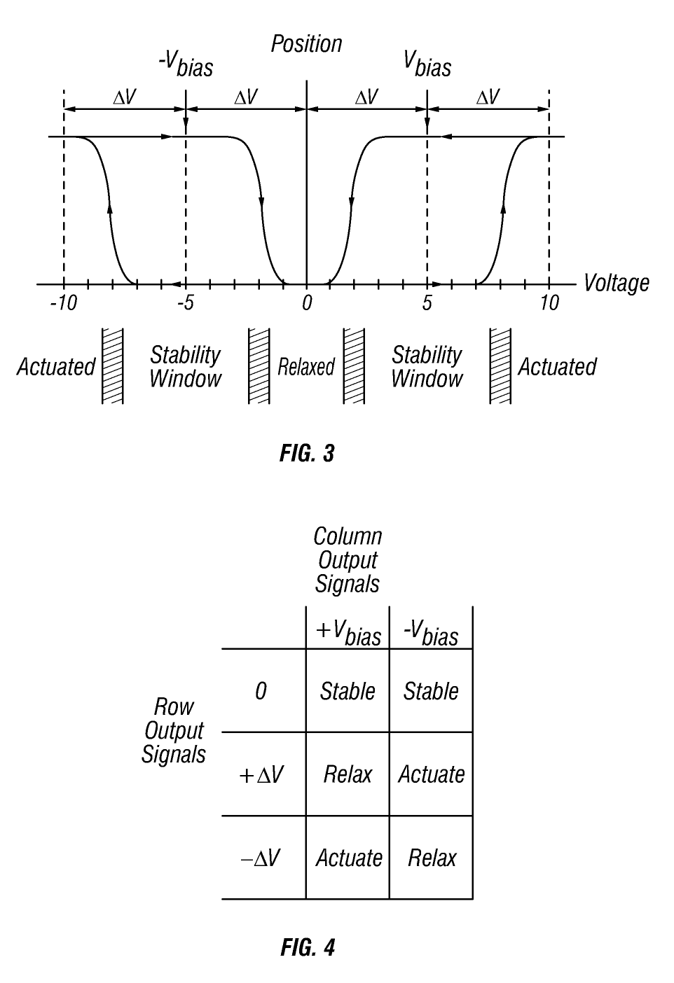

FIG. 3 is a diagram of movable mirror position versus applied voltage for one exemplary embodiment of an interferometric modulator of FIG. 1. For MEMS interferometric modulators, the row/column actuation protocol may take advantage of a hysteresis property of these devices as illustrated in FIG. 3. An interferometric modulator may require, for example, a 10 volt potential difference to cause a movable layer to deform from the relaxed state to the actuated state. However, when the voltage is reduced from that value, the movable layer maintains its state as the voltage drops back below 10 volts. In the exemplary embodiment of FIG. 3, the movable layer does not relax completely until the voltage drops below 2 volts. There is thus a range of voltage, about 3 to 7 V in the example illustrated in FIG. 3, where there exists a window of applied voltage within which the device is stable in either the relaxed or actuated state. This is referred to herein as the “hysteresis window” or “stability window.” For a display array having the hysteresis characteristics of FIG. 3, the row/column actuation protocol can be designed such that during row strobing, pixels in the strobed row that are to be actuated are exposed to a voltage difference of about 10 volts, and pixels that are to be relaxed are exposed to a voltage difference of close to zero volts. After the strobe, the pixels are exposed to a steady state or bias voltage difference of about 5 volts such that they remain in whatever state the row strobe put them in. After being written, each pixel sees a potential difference within the “stability window” of 3-7 volts in this example. This feature makes the pixel design illustrated in FIG. 1 stable under the same applied voltage conditions in either an actuated or relaxed pre-existing state. Since each pixel of the interferometric modulator, whether in the actuated or relaxed state, is essentially a capacitor formed by the fixed and moving reflective layers, this stable state can be held at a voltage within the hysteresis window with almost no power dissipation. Essentially no current flows into the pixel if the applied potential is fixed.

As described further below, in typical applications, a frame of an image may be created by sending a set of data signals (each having a certain voltage level) across the set of column electrodes in accordance with the desired set of actuated pixels in the first row. A row pulse is then applied to a first row electrode, actuating the pixels corresponding to the set of data signals. The set of data signals is then changed to correspond to the desired set of actuated pixels in a second row. A pulse is then applied to the second row electrode, actuating the appropriate pixels in the second row in accordance with the data signals. The first row of pixels are unaffected by the second row pulse, and remain in the state they were set to during the first row pulse. This may be repeated for the entire series of rows in a sequential fashion to produce the frame. Generally, the frames are refreshed and/or updated with new image data by continually repeating this process at some desired number of frames per second. A wide variety of protocols for driving row and column electrodes of pixel arrays to produce image frames may be used.

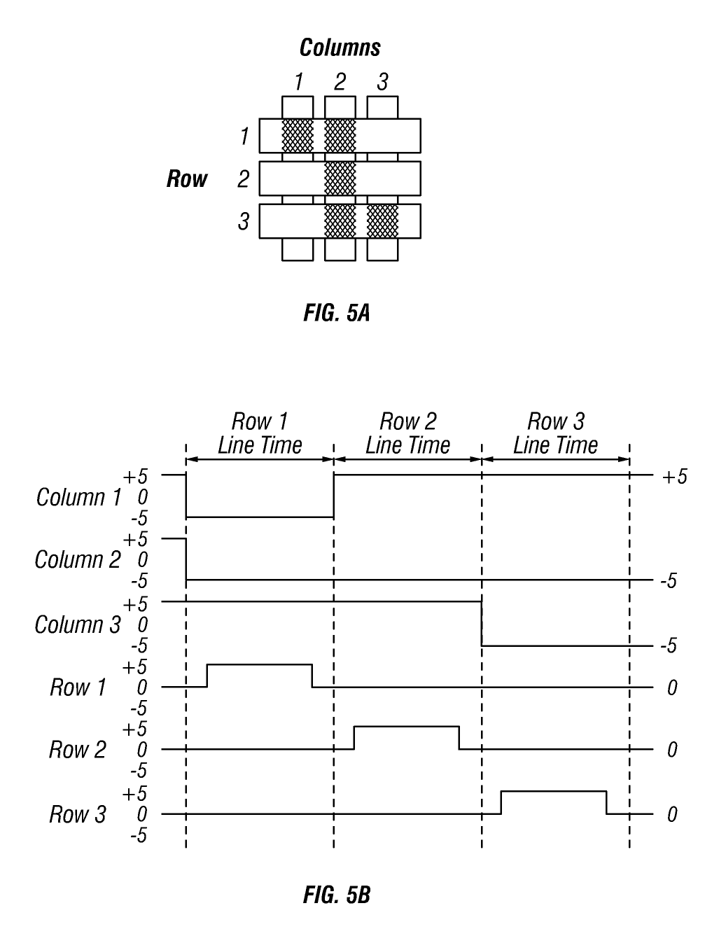

FIGS. 4 and 5 illustrate one possible actuation protocol for creating a display frame on the 3×3 array of FIG. 2. FIG. 4 illustrates a possible set of column and row voltage levels that may be used for pixels exhibiting the hysteresis curves of FIG. 3. In the FIG. 4 embodiment, actuating a pixel involves setting the appropriate column to −V_{bias}, and the appropriate row to +ΔV, which may correspond to −5 volts and +5 volts respectively Relaxing the pixel is accomplished by setting the appropriate column to +V_{bias}, and the appropriate row to the same +ΔV, producing a zero volt potential difference across the pixel. In those rows where the row voltage is held at zero volts, the pixels are stable in whatever state they were originally in, regardless of whether the column is at +V_{bias}, or −V_{bias}. As is also illustrated in FIG. 4, voltages of opposite polarity than those described above can be used, e.g., actuating a pixel can involve setting the appropriate column to +V_{bias}, and the appropriate row to −ΔV. In this embodiment, releasing the pixel is accomplished by setting the appropriate column to −V_{bias}, and the appropriate row to the same −ΔV, producing a zero volt potential difference across the pixel.

FIG. 5B is a timing diagram showing a series of row and column signals applied to the 3×3 array of FIG. 2 which will result in the display arrangement illustrated in FIG. 5A, where actuated pixels are non-reflective. Prior to writing the frame illustrated in FIG. 5A, the pixels can be in any state, and in this example, all the rows are initially at 0 volts, and all the columns are at +5 volts. With these applied voltages, all pixels are stable in their existing actuated or relaxed states.

In the FIG. 5A frame, pixels (1,1), (1,2), (2,2), (3,2) and (3,3) are actuated. To accomplish this, during a “line time” for row 1, columns 1 and 2 are set to −5 volts, and column 3 is set to +5 volts. This does not change the state of any pixels, because all the pixels remain in the 3-7 volt stability window. Row 1 is then strobed with a pulse that goes from 0, up to 5 volts, and back to zero. This actuates the (1,1) and (1,2) pixels and relaxes the (1,3) pixel. No other pixels in the array are affected. To set row 2 as desired, column 2 is set to −5 volts, and columns 1 and 3 are set to +5 volts. The same strobe applied to row 2 will then actuate pixel (2,2) and relax pixels (2,1) and (2,3). Again, no other pixels of the array are affected. Row 3 is similarly set by setting columns 2 and 3 to −5 volts, and column 1 to +5 volts. The row 3 strobe sets the row 3 pixels as shown in FIG. 5A. After writing the frame, the row potentials are zero, and the column potentials can remain at either +5 or −5 volts, and the display is then stable in the arrangement of FIG. 5A. The same procedure can be employed for arrays of dozens or hundreds of rows and columns. The timing, sequence, and levels of voltages used to perform row and column actuation can be varied widely within the general principles outlined above, and the above example is exemplary only, and any actuation voltage method can be used with the systems and methods described herein.

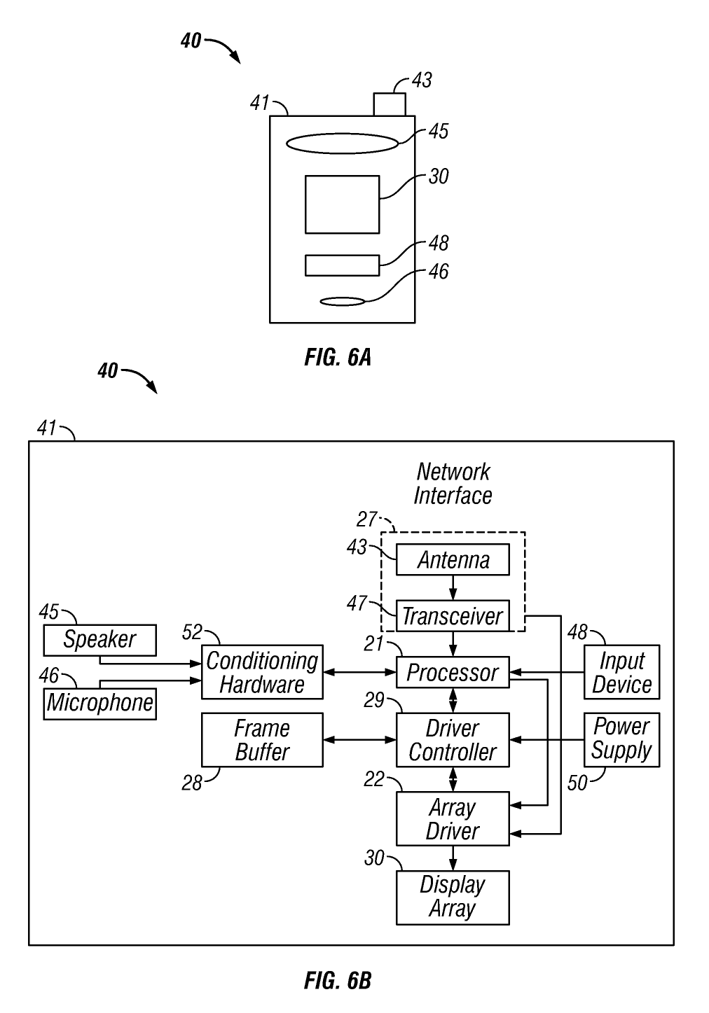

FIGS. 6A and 6B are system block diagrams illustrating an embodiment of a display device 40. The display device 40 can be, for example, a cellular or mobile telephone. However, the same components of display device 40 or slight variations thereof are also illustrative of various types of display devices such as televisions and portable media players.

The display device 40 includes a housing 41, a display 30, an antenna 43, a speaker 45, an input device 48, and a microphone 46. The housing 41 is generally formed from any of a variety of manufacturing processes, including injection molding, and vacuum forming. In addition, the housing 41 may be made from any of a variety of materials, including but not limited to plastic, metal, glass, rubber, and ceramic, or a combination thereof. In one embodiment the housing 41 includes removable portions (not shown) that may be interchanged with other removable portions of different color, or containing different logos, pictures, or symbols.

The display 30 of exemplary display device 40 may be any of a variety of displays, including a bi-stable display, as described herein. In other embodiments, the display 30 includes a flat-panel display, such as plasma, EL, OLED, STN LCD, or TFT LCD as described above, or a non-flat-panel display, such as a CRT or other tube device,. However, for purposes of describing the present embodiment, the display 30 includes an interferometric modulator display, as described herein.

The components of one embodiment of exemplary display device 40 are schematically illustrated in FIG. 6B. The illustrated exemplary display device 40 includes a housing 41 and can include additional components at least partially enclosed therein. For example, in one embodiment, the exemplary display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g. filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 provides power to all components as required by the particular exemplary display device 40 design.

The network interface 27 includes the antenna 43 and the transceiver 47 so that the exemplary display device 40 can communicate with one ore more devices over a network. In one embodiment the network interface 27 may also have some processing capabilities to relieve requirements of the processor 21. The antenna 43 is any antenna for transmitting and receiving signals. In one embodiment, the antenna transmits and receives RF signals according to the IEEE 802.11 standard, including IEEE 802.11(a), (b), or (g). In another embodiment, the antenna transmits and receives RF signals according to the BLUETOOTH standard. In the case of a cellular telephone, the antenna is designed to receive CDMA, GSM, AMPS, W-CDMA, or other known signals that are used to communicate within a wireless cell phone network. The transceiver 47 pre-processes the signals received from the antenna 43 so that they may be received by and further manipulated by the processor 21. The transceiver 47 also processes signals received from the processor 21 so that they may be transmitted from the exemplary display device 40 via the antenna 43.

In an alternative embodiment, the transceiver 47 can be replaced by a receiver. In yet another alternative embodiment, network interface 27 can be replaced by an image source, which can store or generate image data to be sent to the processor 21. For example, the image source can be a digital video disc (DVD) or a hard-disc drive that contains image data, or a software module that generates image data.

Processor 21 generally controls the overall operation of the exemplary display device 40. The processor 21 receives data, such as compressed image data from the network interface 27 or an image source, and processes the data into raw image data or into a format that is readily processed into raw image data. The processor 21 then sends the processed data to the driver controller 29 or to frame buffer 28 for storage. Raw data typically refers to the information that identifies the image characteristics at each location within an image. For example, such image characteristics can include color, saturation, and gray-scale level.

In one embodiment, the processor 21 includes a microcontroller, CPU, or logic unit to control operation of the exemplary display device 40. Conditioning hardware 52 generally includes amplifiers and filters for transmitting signals to the speaker 45, and for receiving signals from the microphone 46. Conditioning hardware 52 may be discrete components within the exemplary display device 40, or may be incorporated within the processor 21 or other components.

The driver controller 29 takes the raw image data generated by the processor 21 either directly from the processor 21 or from the frame buffer 28 and reformats the raw image data appropriately for high speed transmission to the array driver 22. Specifically, the driver controller 29 reformats the raw image data into a data flow having a raster-like format, such that it has a time order suitable for scanning across the display array 30. Then the driver controller 29 sends the formatted information to the array driver 22. Although a driver controller 29, such as a LCD controller, is often associated with the system processor 21 as a stand-alone Integrated Circuit (IC), such controllers may be implemented in many ways. They may be embedded in the processor 21 as hardware, embedded in the processor 21 as software, or fully integrated in hardware with the array driver 22.

Typically, the array driver 22 receives the formatted information from the driver controller 29 and reformats the video data into a parallel set of waveforms that are applied many times per second to the hundreds and sometimes thousands of leads coming from the display's x-y matrix of pixels.

In one embodiment, the driver controller 29, array driver 22, and display array 30 are appropriate for any of the types of displays described herein. For example, in one embodiment, driver controller 29 is a conventional display controller or a bi-stable display controller (e.g., an interferometric modulator controller). In another embodiment, array driver 22 is a conventional driver or a bi-stable display driver (e.g., an interferometric modulator display). In one embodiment, a driver controller 29 is integrated with the array driver 22. Such an embodiment is common in highly integrated systems such as cellular phones, watches, and other small area displays. In yet another embodiment, display array 30 is a typical display array or a bi-stable display array (e.g., a display including an array of interferometric modulators).

The input device 48 allows a user to control the operation of the exemplary display device 40. In one embodiment, input device 48 includes a keypad, such as a QWERTY keyboard or a telephone keypad, a button, a switch, a touch-sensitive screen, a pressure- or heat-sensitive membrane. In one embodiment, the microphone 46 is an input device for the exemplary display device 40. When the microphone 46 is used to input data to the device, voice commands may be provided by a user for controlling operations of the exemplary display device 40.

Power supply 50 can include a variety of energy storage devices as are well known in the art. For example, in one embodiment, power supply 50 is a rechargeable battery, such as a nickel-cadmium battery or a lithium ion battery. In another embodiment, power supply 50 is a renewable energy source, a capacitor, or a solar cell, including a plastic solar cell, and solar-cell paint. In another embodiment, power supply 50 is configured to receive power from a wall outlet.

In some implementations control programmability resides, as described above, in a driver controller which can be located in several places in the electronic display system. In some cases control programmability resides in the array driver 22. The above-described optimization may be implemented in any number of hardware and/or software components and in various configurations.

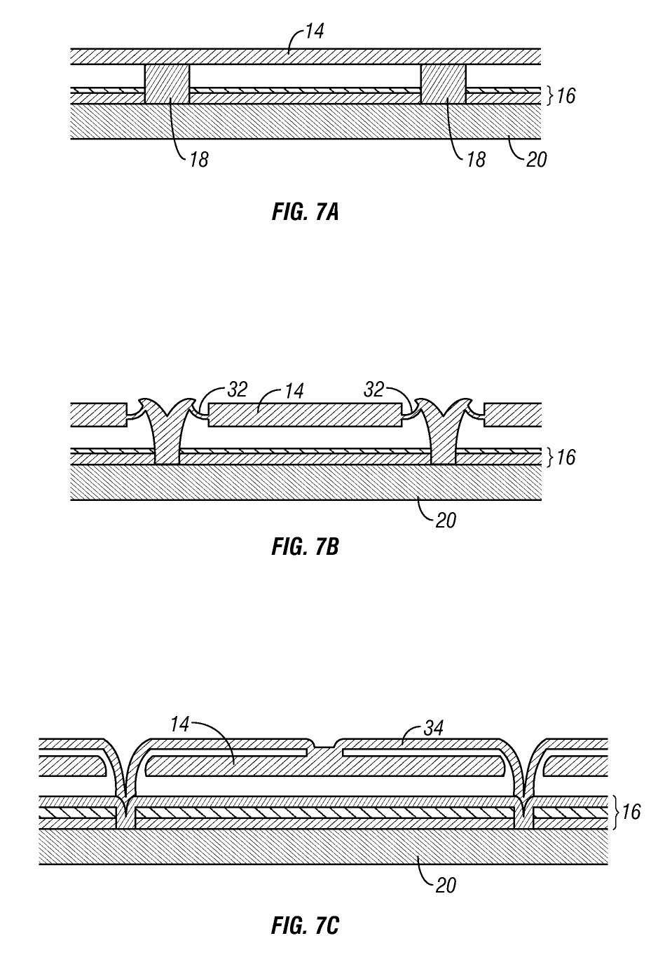

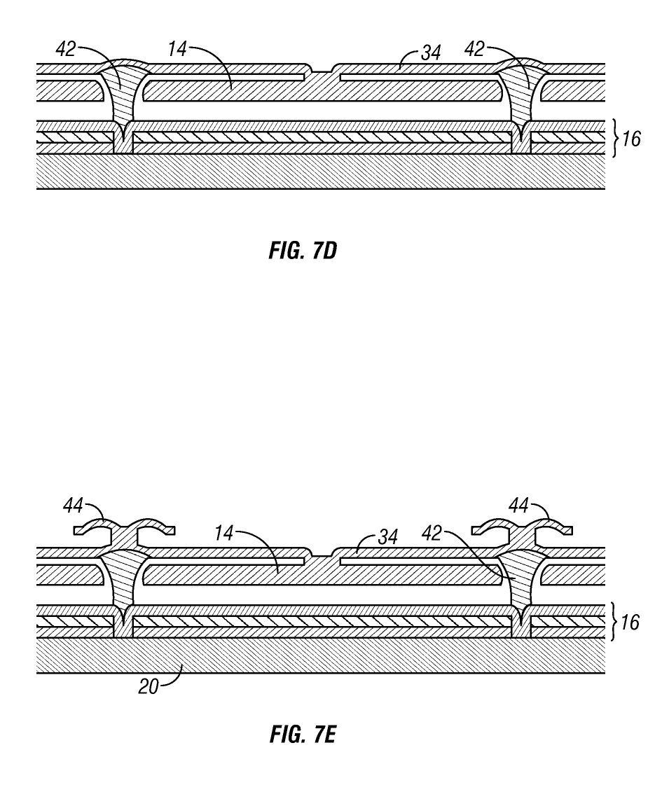

The details of the structure of interferometric modulators that operate in accordance with the principles set forth above may vary widely. For example, FIGS. 7A-7E illustrate five different embodiments of the movable reflective layer 14 and its supporting structures. FIG. 7A is a cross section of the embodiment of FIG. 1, where a strip of metal material 14 is deposited on orthogonally extending supports 18. In FIG. 7B, the moveable reflective layer 14 of each interferometric modulator is square or rectangular in shape and attached to supports at the corners only, on tethers 32. In FIG. 7C, the moveable reflective layer 14 is square or rectangular in shape and suspended from a deformable layer 34, which may comprise a flexible metal. The deformable layer 34 connects, directly or indirectly, to the substrate 20 around the perimeter of the deformable layer 34. These connections are herein referred to as support posts. The embodiment illustrated in FIG. 7D has support post plugs 42 upon which the deformable layer 34 rests. The movable reflective layer 14 remains suspended over the gap, as in FIGS. 7A-7C, but the deformable layer 34 does not form the support posts by filling holes between the deformable layer 34 and the optical stack 16. Rather, the support posts are formed of a planarization material, which is used to form support post plugs 42. The embodiment illustrated in FIG. 7E is based on the embodiment shown in FIG. 7D, but may also be adapted to work with any of the embodiments illustrated in FIGS. 7A-7C as well as additional embodiments not shown. In the embodiment shown in FIG. 7E, an extra layer of metal or other conductive material has been used to form a bus structure 44. This allows signal routing along the back of the interferometric modulators, eliminating a number of electrodes that may otherwise have had to be formed on the substrate 20.

In embodiments such as those shown in FIG. 7, the interferometric modulators function as direct-view devices, in which images are viewed from the front side of the transparent substrate 20, the side opposite to that upon which the modulator is arranged. In these embodiments, the reflective layer 14 optically shields the portions of the interferometric modulator on the side of the reflective layer opposite the substrate 20, including the deformable layer 34. This allows the shielded areas to be configured and operated upon without negatively affecting the image quality. For example, such shielding allows the bus structure 44 in FIG. 7E, which provides the ability to separate the optical properties of the modulator from the electromechanical properties of the modulator, such as addressing and the movements that result from that addressing. This separable modulator architecture allows the structural design and materials used for the electromechanical aspects and the optical aspects of the modulator to be selected and to function independently of each other. Moreover, the embodiments shown in FIGS. 7C-7E have additional benefits deriving from the decoupling of the optical properties of the reflective layer 14 from its mechanical properties, which are carried out by the deformable layer 34. This allows the structural design and materials used for the reflective layer 14 to be optimized with respect to the optical properties, and the structural design and materials used for the deformable layer 34 to be optimized with respect to desired mechanical properties.

Light incident on an interferometric modulator is either reflected or absorbed due to constructive or destructive interference, depending on the distance between the optical stack 16 and the reflective layer 14. The perceived brightness and quality of a display using interferometric modulators is dependent on the light incident on the display, since that light is reflected to produce an image in the display. In some circumstances, such as in low ambient light conditions, an illumination system may be used to illuminate the display to produce an image.

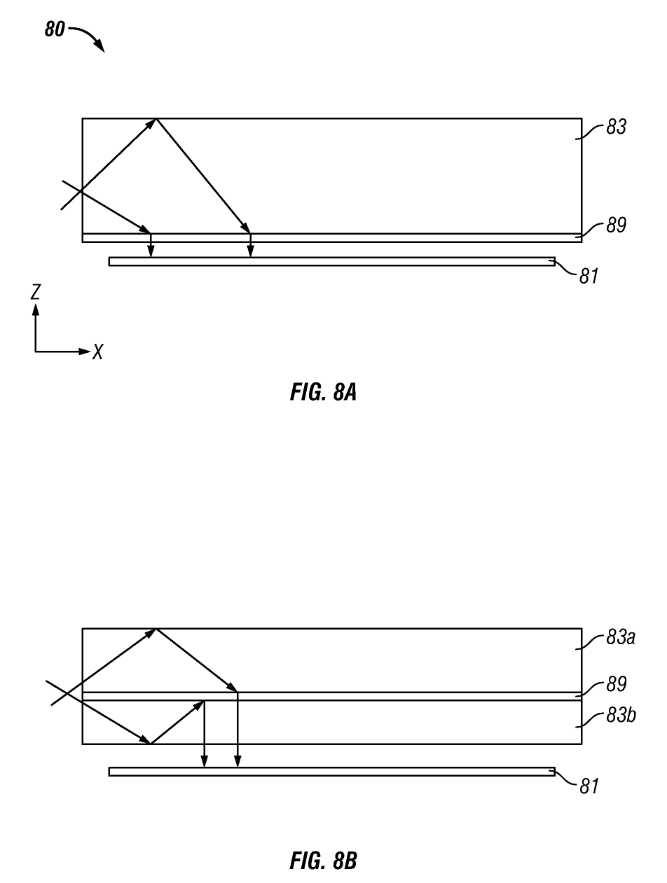

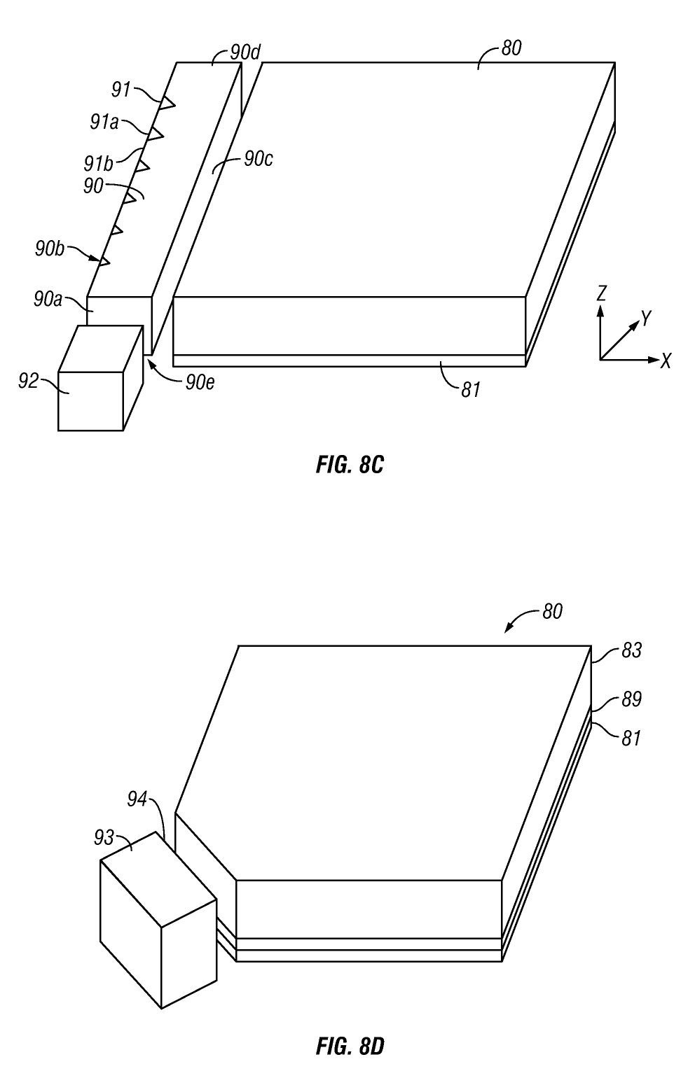

FIG. 8A is a cross-sectional view of a display device including an illumination system that includes a light guide panel 80 disposed adjacent a display 81. The light guide panel 80 includes a holographic light turning film 89 having a hologram recorded in it. In some embodiments, the holographic film 89 is attached to and supported by a support plate 83, as illustrated. The display 81 can include various display elements, e.g., a plurality of spatial light modulators, interferometric modulators, liquid crystal elements, etc., which can be arranged parallel the major surface of the holographic film 89. The holographic film 89 directs light propagating through the light guide panel 80 into the display 81. In some embodiments, the illumination system is a front light and light reflected from the display 81 is transmitted back through and out of the light guide panel 80 towards the user. The display 81 can be the display 30 (FIGS. 6A and 6B) in some embodiments.

The holographic film 89 is formed of a material that can support the formation of a hologram and also support the propagation of light through the film 89. In some embodiments, the support plate 83 is also formed of a material that can support the propagation of light through the plate 83 and has sufficient structural integrity to support the holographic film 89. For example, the support plate 83 can be formed of glass, plastic or other highly transparent material. In some embodiments, the support plate 83 is directly attached to the holographic film 89; the plate 83 and the holographic film 89 form a single unit through which light propagates via, e.g., total internal reflective. In other embodiments, the plate 83 is coupled to the holographic film 89 by a refractive index matching layer which facilitates the propagation of light from the plate 83 into the holographic film 89 and vice versa, for total internal reflection.

In some other embodiments, the plate 83 and the holographic film 89 are optically decoupled and the light turned towards the display is substantially propagated by total internal reflection through the holographic film 89 only. The plate 83 and the holographic film 89 can be optically decoupled due to differences in the refractive indexes of the materials forming these parts, or due to a refractive index decoupling layer inserted between these parts. It will be appreciated that the refractive index decoupling layer can have a refractive index sufficiently different from the material of the plate 83 and/or holographic film 89 to minimize the propagation of light between the plate 83 and the holographic film 89.

With reference to FIG. 8B, in some other embodiments, the holographic film 89 is disposed between two support plates 83a and 83b, for further mechanical support and/or to protect the holographic film 89. The plate 83a may be formed of a similar material as the plate 83b. The holographic film 89 may be optically coupled or decoupled from the plates 83a and 83b, as discussed above with reference to FIG. 8A. In some arrangements, the holographic film 89 can be coupled to one of the plates 83a, 83b and decoupled from the other of the plates 83a, 83b.

As shown in FIG. 8C, light may be injected into the light guide panel by a light source that includes a light bar 90. The light bar 90 has a first end 90a for receiving light from a light emitter 92. The light emitter 92 may include a light emitting diode (LED), although other light emitting devices are also possible. The light bar 90 includes substantially optically transmissive material that supports propagation of light along the length of the light bar 90. Light emitted from the light emitter 92 propagates into the light bar 90. The light is guided therein, for example, via total internal reflection at sidewalls thereof, which form interfaces with air or some other surrounding fluid or solid medium. For example, where the light bar 90 is formed of a material with a similar refractive index as the light panel 80 and as the holographic film 89, the light bar 90 can be separated from the panel 80 by air, fluid or solid medium to promote total internal reflection within the light bar 90.

The light bar 90 includes a turning microstructure on at least one side, for example, the side 90b that is substantially opposite the light guide panel 80. The turning microstructure is configured to turn light incident on that side 90b of the light bar 90 and to direct that light out of the light bar 90 (e.g., out side 90c) into the panel 80. The turning microstructure of the light bar 90 includes a plurality of turning features 91 having facets 91a that reflect incident light towards the panel 80. It will be appreciated that the features 91 shown in FIG. 8C are schematic and exaggerated in size and the spacing therebetween. The sizes, shapes, densities, position, etc. of the features 91 can vary from that depicted to achieved the desired light turning effect.

The illumination apparatus can further include a coupling optic (not shown) between the light bar 90 and the light guide panel 80. For example, the coupling optic may collimate, magnify, diffuse, change the color, etc., of light propagating from the light bar 90.

Accordingly, light travels from the first end 90a in the direction of a second end 90d of the light bar 90, and can be reflected back again towards the first end 90a. Along the way, the light can be turned towards an adjacent light guide panel 80. The light guide panel 80 is disposed with respect to the light bar 90 so as to receive light that has been turned by the turning microstructure and directed out of the light bar 90.

With reference to FIG. 8D, in preferred embodiments, the light source can be a point light source 93, which has advantages for simplifying the illumination system, the display device, and their manufacture. The point light source 93 can be a light emitting diode (LED), or other light emitting device. In the illustrated embodiment, the point source 93 is disposed at an edge, e.g., a corner, of the light guide panel 80. A light emitting face 94 of the point source 93 faces the edge of the panel 80. It will be appreciated that light escapes the point source 93 from the light emitting face 94. The point source 93 disperses light over a range of angles, on the plane of the light panel 80, which is sufficient to inject light throughout the light panel 80. In other embodiments, depending upon whether the point source 93 disperses light over a range of angles sufficient for a desired injection of light into the light panel 80, the point source 93 can be positioned at locations other than the corner of the light panel 80. For example, a point source 93 that disperses light over a 180° arc may be positioned in, e.g., a notch in an edge of the panel 80.

With continued reference to FIG. 8D, the light guide panel 80 includes the support plate 83 and the holographic film 89, which are disposed facing the display 81. As discussed above, the light guide panel 80 can be provided with additional support plates, e.g., to sandwich the holographic film 89, and/or refractive index coupling or decoupling layers between the support plates and the holographic film 89.

After being injected into the light guide panel 80 by a light source, e.g., the point source 93 (FIG. 8D), light propagating through the panel 80 is redirected towards the display 81 (FIGS. 8A-8D) by diffractive, refractive index (DRI) structures formed in the panel 80.

The DRI structures can be distributed over the holographic film 89 in various patterns to achieved desired light turning properties. It will be appreciated that uniformity of power per area is desired in many applications to uniformly light the display 81. The DRI structures may be arranged to achieve good uniformity in power per area. In some embodiments, the power per area of light directed towards the display 81 is substantially uniform over the area of the holographic film 83 corresponding to the display 81. In certain embodiments, the ratio of the minimum to maximum flux of redirected light per area, over the total area of the holographic film corresponding to picture elements of the display, is greater than 0.20.

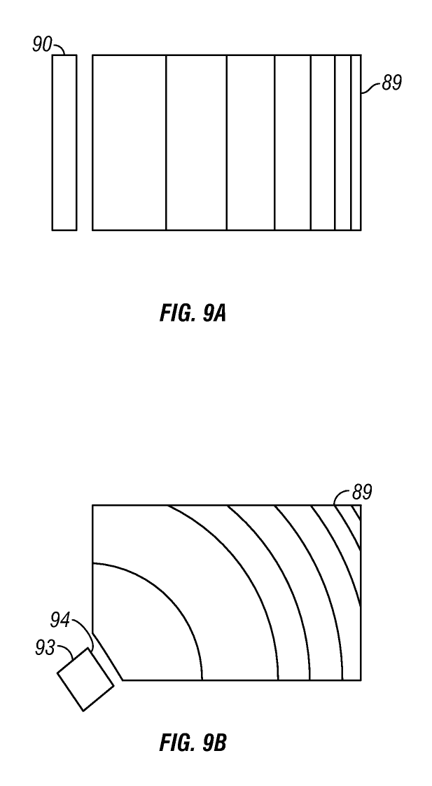

With reference to FIGS. 9A and 9B, the density of the DRI structures increases with increasing distance from the light source. With reference to FIG. 9A, the number of DRI structures per unit area increases with increasing distance from the edge of the holographic film directly adjacent the line source 90. With reference to FIG. 9B, the number of DRI structures per unit area increases with distance from the point source 93. The increase in DRI structure density is represented schematically by the density of shading in FIGS. 9A and 9B.

In some embodiments, the varying density of the DRI structures allows the flux of light redirected per unit area to be highly uniform over the area of the holographic film 89 corresponding to the display 81 (FIGS. 8A-8D). As light propagates through the light guide panel 80, some amount of light contacts the DRI structures and is redirected out of the panel 80. Thus, the remaining amount of light propagating through the panel 80 decreases with distance from the light source, as more and more light is redirected by contact with DRI structures. To compensate for the decreasing amounts of light propagating through the panel 80, the density of DRI structures may increase with distance from the light source.

It will be appreciated that the density of the DRI structures is related to the extraction efficiency of the light guide panel 80. The extraction efficiency is a measure of the amount of light directed out of the panel 80 as compared to the amount of light that continues to propagate within the panel 80. Due to increases in the density of the DRI structures with increasing distance from the light source, the extraction efficiency is higher farther from a light source and decreases closer to the light source. In general, to promote the propagation of light through the panel 80, the extraction efficiency is low. In some embodiments, the extraction efficiency is about 50% or less, or about 40% or less. Thus, less than about 50%, or less than about 40%, of the light propagating through the panel 80 is directed out of the panel 80.

It will be appreciated that the density of the DRI structures in the panel 80 refers to the volume occupied by DRI structures per unit volume of the panel 80. A single large DRI structure or a plurality of smaller DRI structures in a given volume may have the same density. Thus, the density may be changed due to, e.g., changes in the sizes and/or numbers of the DRI structures per volume.

The DRI structures are elements of a hologram and are formed by recording the hologram in a holographic film. The hologram can be recorded by various methods known in the art.

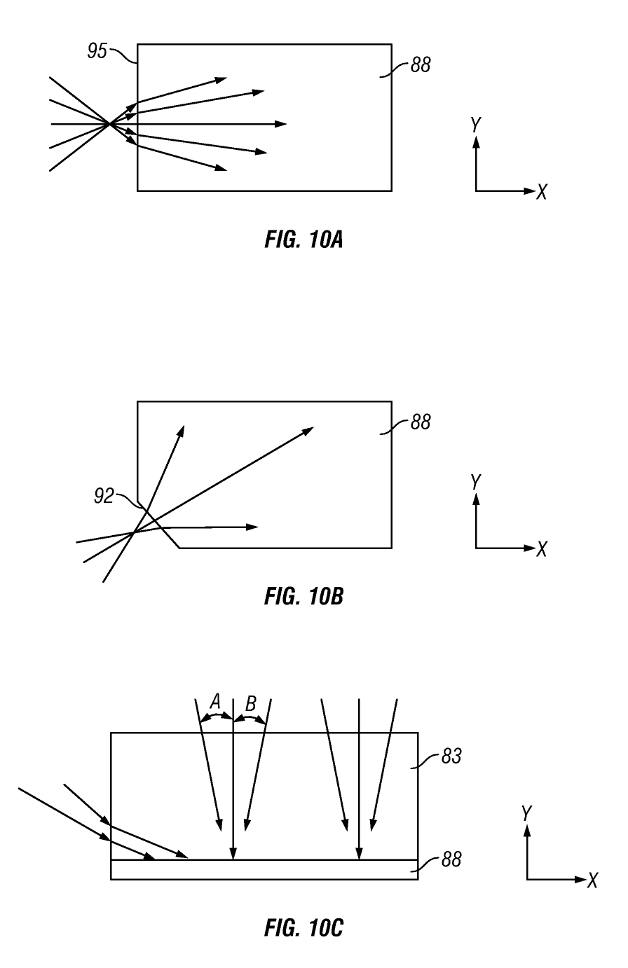

In some embodiments, with reference to FIGS. 10A-10C, a holographic film 88 is provided for recording. As illustrated, the holographic film 88 can be provided attached to the support plate 83. In other embodiments, the holographic film 88 can be attached to the support plate 83 after recordation of the hologram.

While termed a “film” for ease of description herein, the holographic films 88, 89 (FIGS. 8A-9B) can assume various three-dimensional shapes other than a sheet or simple layer of material. Moreover, the holographic films 88, 89 can be formed of one or more materials capable of forming a hologram and supporting the propagation of light through the medium. Examples of materials for the holographic films 88, 89 include dichromate gelatin, photopolymer films, silver halide emulsions and other materials known in the art.

With continued reference to FIGS. 10A-10C, a hologram is recorded in the holographic film 88 to form the holographic film 89 (FIGS. 8A-9B), which has the recorded hologram therein. Multiple laser beams are directed to the holographic film 88 from two principle directions. A first set of laser beams are directed into the holographic film 88 from an edge of the film and a second set of laser beams are incident on a major surface of the holographic film 88.

The direction and the incidence of this first set of laser beams correspond to the direction and incidence of light that will later be directed into the holographic film 88 from a light source. In some embodiments, with reference to FIG. 10A, the laser beams are incident on an edge 95 into which light from a line light source will later be injected into the film 88. In some other embodiments, with reference to FIG. 10B, the laser beams are incident on an edge 92 into which light from a point light source will later be injected into the film 88.

The second set of laser beams is directed onto a major surface of the holographic film 88 and correspond to the desired direction and location of light redirected from a light source out of the holographic film 89 (FIGS. 8A-9B). In some embodiments, with reference to FIG. 10C, the second set of laser beams is directed substantially normal to the holographic film 88, and also in a range of angles from about A to about B, relative to the normal. In some embodiments, angles A and B are equal and are 30° or less, or about 15° or less. In certain embodiments, the range of angles from A to B correspond to the desired viewing angles for a display that will be lit by the light turned by the holographic film 89. For example, the resulting DRI structures can redirect light out of the major surface of the holographic film 89 in a cone extending over angles of about ±30° or less, or about ±15° or less as measured relative to a normal to the major surface. The relatively narrow cone of light can be beneficial for the perceived brightness of the display 81, since the light redirected out of the holographic film 89 is focused over a narrower range. In addition, in some applications, the relatively narrow cone of light can be desirable for privacy benefits, since the narrow cone limits the viewing angles of the display 81.

The display lit by the holographic film 89 may be a color display having pixels that display different colors. Consequently, in some embodiments, the recorded DRI structures are designed to turn light corresponding to the colors displayed by those pixels. For example, the pixels may display light corresponding to the colors red, green and blue, with different combinations of these colors forming various colors. As a result, the DRI structures can be formed to diffract light predominantly at wavelengths corresponding to the colors red, green and blue. This may be accomplished by, e.g., using a mask with openings that allow illumination of selected portions of the holographic film in a first position, and shifting the mask to other positions, e.g., second and third other positions, while exposing the holographic film to light while the mask is in each position, to form areas or “pixels” for turning of different desired wavelengths or colors, such as red, green and blue. At each position, the holographic film can be exposed to laser light of a different wavelength, the wavelength of the laser light chosen to correspond to the color of the light that the pixels are desired to turn. The laser light includes laser beams oriented substantially normal to the holographic film. In addition, a secondary beam, which can have the same wavelength as the substantially normal laser beam, is directed into the holographic film at the same angle and direction as a desired angle and direction of light from a later-installed light source for illuminating the display. The pixels areas are non-overlapping and can be laterally separated. Thus, a pixilated holographic film can be formed, with each pixel preferentially turning a specific color. In other embodiments, laser beams with a range of different wavelengths can be simultaneously directed to the holographic film to simultaneously form DRI structures that predominately turn desired wavelengths of light.

In other arrangements, the wavelength of the laser light can be kept constant, and the holographic film can be made to turn different wavelengths of light by changing the angle between beams of laser light used to form the DRI structures. Such an arrangement can be applied to form the desired DRI structures in holographic recording materials that do not respond to all wavelengths of laser light that would otherwise be used to form the DRI structures. Advantageously, wavelengths of laser light to which the holographic material responds can be used to form all the DRI structures, with the angle between the beams of the laser light varied as needed to achieve light turning at the desired wavelengths of light.

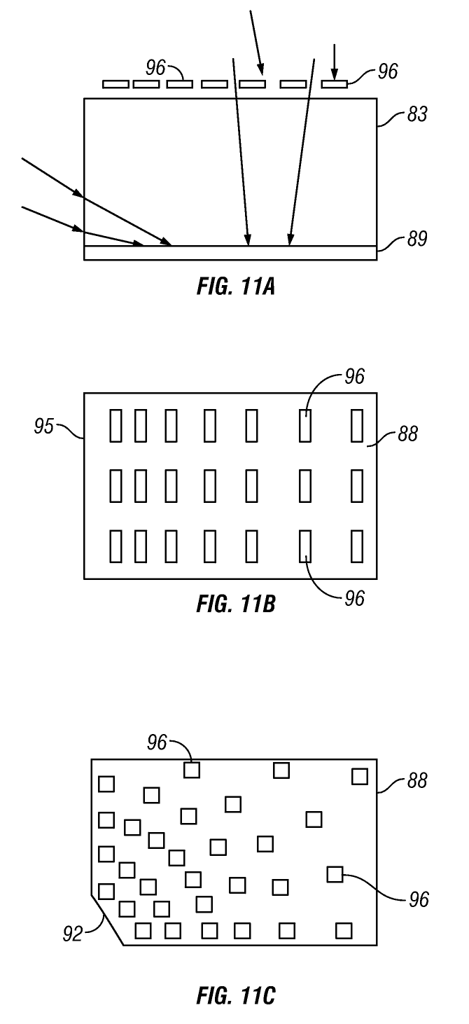

With reference to FIGS. 11A-11C, the DRI structures can be formed having a density that increases with increasing distance from a light source. This change in density can be achieved during hologram recordation using a mask having a plurality of laser or light blocking structures 96. The density of the light blocking structures 96 decreases with increasing linear distance from a light source. As a result, more laser light is allowed through the mask and onto the holographic film 88 with increasing distance from the light source, thereby forming a higher density of the DRI structures with the increasing distance. As shown in FIG. 11B, the density of the light blocking structures 96 can decrease with distance to the edge 90, where a line light source is to be paired with the holographic film 88. As shown in FIG. 11C, the density of the light blocking structures 96 can decrease with distance to the edge 92, where a point light source is to be paired with the holographic film 88. After recordation, the light blocking structures 96 correspond to areas in the holographic film that are devoid of DRI structures.

It will be appreciated that the relative sizes of the light blocking structures 96 and the film 88 have been exaggerated for ease of illustration. In some embodiments, the light blocking structures 96 are small to facilitate uniformity in light turning. The light blocking structures 96 can have a regular shape, such as a rectangular shape. In other embodiments, the light blocking structures can have other shapes or vary in shape and/or size.

After recordation of the hologram, a light source, such as the line or point sources 90, 93, are attached to the holographic film 89 (FIGS. 8A-9B), in some embodiments. A display 81 is also attached to the holographic film 89, thereby forming a display device having an illumination system including the film 89, in some embodiments.

It will be understood by those skilled in the art that, although this invention has been disclosed in the context of certain preferred embodiments and examples, the present invention extends beyond the specifically disclosed embodiments to other alternative embodiments and/or uses of the invention and obvious modifications and equivalents thereof. In addition, while several variations of the invention have been shown and described in detail, other modifications, which are within the scope of this invention, will be readily apparent to those of skill in the art based upon this disclosure. It is also contemplated that various combinations or sub-combinations of the specific features and aspects of the embodiments may be made and still fall within the scope of the invention. It should be understood that various features and aspects of the disclosed embodiments can be combined with, or substituted for, one another in order to form varying modes of the disclosed invention. Thus, it is intended that the scope of the present invention herein disclosed should not be limited by the particular disclosed embodiments described above, but should be determined only by the claims that follow.

We claim:

1. An illumination apparatus, comprising:
a holographic film comprising a hologram, the hologram comprising a plurality of diffractive refractive index structures,
the holographic film configured to couple to a point light source disposed at an edge of the holographic film such that a light emitting face of the point light source faces the edge,
wherein a density of the diffractive refractive index structures increases with increasing distance from the light source.

2. The apparatus of claim 1, wherein the holographic film comprises a plurality of regularly shaped areas devoid of the diffractive refractive index structures, wherein a density of the regularly shaped areas decreases with increasing distance to the light source.

3. The apparatus of claim 2, wherein the regularly shaped areas have a rectangular shape.

4. The apparatus of claim 1, wherein the diffractive refractive index structures are configured to diffract light from the light source, the diffracted light rays propagating out of a major surface of the holographic film at angles of ±b 30° or less as measured relative to a line normal to the major surface.

5. The apparatus of claim 4, wherein the angles are ±15° or less.

6. The apparatus of claim 1, wherein the plurality of diffractive refractive index structures has an extraction efficiency of about 50% or less.

7. The apparatus of claim 1, further comprising the light source localized at a corner of the holographic film and configured to direct light into the holographic film only from the corner.

8. The apparatus of claim 7, wherein the light source is a light emitting diode.

9. The apparatus of claim 1, wherein the diffractive refractive index structures are configured to diffract light predominantly at wavelengths corresponding to the colors red, green and blue.

10. The apparatus of claim 9, wherein the holographic film is attached to a glass plate, wherein a refractive index matching layer is disposed between the holographic film and the glass plate.

11. The apparatus of claim 9, wherein the holographic film is attached to a glass plate, wherein a refractive index decoupling layer is disposed between the holographic film and the glass plate.

12. The apparatus of claim 9, further comprising a plurality of interferometric modulators attached parallel to a major surface of the holographic film.

13. The apparatus of claim 12, wherein the diffractive refractive index structures are grouped into three sets of non-overlapping, laterally adjacent pixels, each set of pixels predominantly turning light corresponding to a color different from light predominantly turned by the other sets of pixels.

14. An illumination apparatus, comprising:
a first means for generating light and directing the light through a planar body; and
a second means for uniformly holographically redirecting the light out of a surface of the body.

15. The apparatus of claim 14, wherein the second means comprises a hologram comprising a plurality of diffractive refractive index structures, the hologram recorded in the planar body.

16. The apparatus of claim 15, wherein the first means comprises a light emitting diode.

17. The apparatus of claim 16, wherein the light emitting diode is localized at a corner of the holographic film.

18. The apparatus of claim 14, further comprising a third means for displaying an image through the planar body.

19. The apparatus of claim 18, wherein the third means comprises a plurality of interferometric modulators, the interferometric modulators forming pixel elements.

20. The apparatus of claims 1, further comprising:
a display;
a processor that is configured to communicate with the display, the processor being configured to process image data; and
a memory device that is configured to communicate with the processor.

21. The apparatus of claim 20, further comprising a driver circuit configured to send at least one signal to the display.

22. The apparatus of claim 21, further comprising a controller configured to send at least a portion of the image data to the driver circuit.

23. The apparatus of claim 20, further comprising an image source module configured to send the image data to the processor.

24. The apparatus of claim 23, wherein the image source module comprises at least one of a receiver, transceiver, and transmitter.

25. The apparatus of claim 20, further comprising an input device configured to receive input data and to communicate the input data to the processor.

26. A method for illuminating a display, comprising:
providing a point light source at an edge of a holographic film;
projecting light from the point light source directly into the edge of the holographic film, the light propogating through the holographic film; and
contacting the light with diffractive refractive index structures to direct the light out of a major surface of the holographic film, wherein power per area of light redirected towards picture elements of the display is substantially uniform across the major surface of the holographic film.

27. The method of claim 26, wherein the ratio of the minimum to maximum flux of redirected light per area, over the entire area of the holographic film corresponding to picture elements of the display, is greater than 0.20.

28. A method for manufacturing a display device, comprising:
providing a holographic film comprising a hologram, the hologram comprising a plurality of diffractive refractive index structures;
attaching a point light source at an edge of the holographic film, a light emitting face of the point light source facing the edge; and
attaching a display to the holographic film,
wherein a density of the diffractive refractive index structures increases with increasing distance from the light source.

29. The method of claim 28, wherein providing the holographic film comprising the hologram comprises:
exposing a holographic film to a first laser beam directed substantially normal to the holographic film; and
simultaneously exposing the holographic film to a second laser beam, the second laser beam directed into the holographic film at a same angle and direction as a desired angle and direction of light from the light source.

30. The method of claim 29, further comprising providing a plurality of light blocking structures adjacent the holographic film, the light blocking structures shielding some areas of the holographic film from the first laser beam, wherein a linear density of the light blocking structures decreases with increasing distance from a desired placement of the light source.

31. The method of claim 28, wherein providing the holographic film comprising the hologram comprises:
exposing the holographic film to a first laser beam through a mask comprising a plurality of openings, the mask in a first position relative to the holographic film;
shifting the mask to a second position;
exposing the holographic film to a second laser beam through the mask at the second position;
shifting the mask to a third position; and
exposing the holographic film to a third laser beam through the mask at the third position,
wherein exposing the holographic film to the first, second and third laser beams comprise simultaneously exposing the holographic film to a secondary laser beam directed into the holographic film at a same angle and direction as a desired angle and direction of light from the light source.

32. The method of claim 31, wherein the first, second and third laser beams have wavelengths corresponding to different colors.

33. The method of claim 32, wherein a wavelength of the secondary laser varies depending upon a wavelength of the first, second and third laser beams,
wherein the secondary laser beam is substantially equal to the wavelength of the first laser beam during exposing the holographic film to the first laser beam,
wherein the wavelength of the secondary laser beam is substantially equal to the wavelength of the second laser beam during exposing the holographic film to the second laser beam, and
wherein the wavelength of the secondary laser beam is substantially equal to the wavelength of the third laser beam during exposing the holographic film to the third laser beam.

34. A display device fabricated by the method of claim 28.
